(19) United States
(12) Patent Application Publication
(10) Pub. No.: US 2018/0183921 A1
(43) Pub. Date: Jun. 28, 2018

(54) MOBILE TERMINAL AND METHOD FOR CONTROLLING THE SAME

(71) Applicant: LG ELECTRONICS INC., Seoul (KR)

(72) Inventors: Younhwa CHOI, Seoul (KR); Yoojin CHOI, Seoul (KR); Huran CHOI, Seoul (KR)

(73) Assignee: LG ELECTRONICS INC., Seoul (KR)

(21) Appl. No.: 15/677,529

(22) Filed: Aug. 15, 2017

(30) Foreign Application Priority Data
Dec. 22, 2016 (KR) 10-2016-0176309

(51) Int. Cl. H04M 1/725; H04W 4/12; G06F 3/0488; G06F 3/0489; G06F 3/0481; G06F 3/0482

(52) U.S. Cl. CPC H04M 1/72552; H04M 1/72583; H04W 4/12; G06F 3/0482; G06F 3/0489; G06F 3/04817; G06F 3/04886

(57) ABSTRACT

A mobile terminal including a wireless communication processor configured to wirelessly receive a message from another terminal; a touchscreen configured to display contents of the received message; and a controller configured to in response to a first control input on the displayed message, display a reply interface including a recommendation reply area having plurality of preset response options for responding to the received message, based on a current status of the mobile terminal and a meaning of the contents of the received message.

### CROSS REFERENCE TO RELATED APPLICATIONS

Pursuant to 35 U.S.C. § 119(a), this application claims the benefit of earlier filing date and right of priority to Korean Application No. 10-2016-0176309, filed on Dec. 22, 2016, the contents of which are hereby incorporated by reference herein in their entirety.

### BACKGROUND OF THE INVENTION

### Field of the Invention

The present invention relates to a mobile terminal providing a reply interface to quickly transmit a reply when a message is received in a lock mode and a method of controlling therefor.

### Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mounted terminals. There are ongoing efforts to support and increase the functionality of mobile terminals. Such efforts include software and hardware improvements, as well as changes and improvements in the structural components which form the mobile terminal.

Meanwhile, when a user intends to send a reply in response to a message received in a mobile terminal, if the mobile terminal is in a state of being actively used, the user quickly drives a message application and can then send the reply. However, if the mobile terminal is in a state of being passively used, for example, if a display unit of the mobile terminal is not activated or if a lock screen is output although the display unit is activated, since it is necessary for the user to cancel a lock state and drive the message application to send a reply, it is required to perform job of an unnecessary step and it takes time for the job.

Hence, a simple and prompt method is needed capable of sending a reply in response to a received message even when the mobile terminal is not actively used by a user.

### SUMMARY OF THE INVENTION

Accordingly, an object of the present invention is to address the above-noted and other problems.

An object of the present invention is to solve the aforementioned problem and other problems. Another object of the present invention is to provide a mobile terminal capable of providing a user-specific reply interface in a lock state and a method of controlling therefor.

The other object of the present invention is to provide a mobile terminal capable of providing a reply interface including a recommendation reply area and a variable area in consideration of a received message and a current status of the mobile terminal and a method of controlling therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a mobile terminal includes a display unit, a sensing unit, a wireless communication unit, and a controller, if a first control input on a received message is sensed, configured to provide a reply interface outputting a recommendation reply area on the display unit. In this instance, the recommendation reply area includes at least one speech bubble which is output based on contents of the received message. And, at least one of a size and a color of the at least one speech bubble can be differently output according to a predetermined criteria.

To further achieve these objects and other advantages and in accordance with the purpose of the invention, as embodied and broadly described herein, according to a different embodiment, a method of controlling a mobile terminal, includes the steps of receiving a message, sensing a first control input on the received message, recognizing a current status of the mobile terminal and contents of the received message, extracting an option to be included in a reply interface according to the recognized current status and the contents of the received message, and providing the reply interface outputting a recommendation reply area.

It is to be understood that both the foregoing general description and the following detailed description of the preferred embodiments of the present invention are exemplary and explanatory and are intended to provide further explanation of the invention as claimed.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure.

FIGS. 1B and 1C are conceptual views of one example of the mobile terminal, viewed from different directions;

FIG. 2 is a block diagram illustrating a mobile terminal according to one embodiment of the present invention;

FIG. 3 is a diagram illustrating an example of providing a reply interface in a mobile terminal according to one embodiment of the present invention;

FIG. 4 is a diagram illustrating a different example of providing a reply interface in a mobile terminal according to one embodiment of the present invention;

FIG. 5 is a diagram illustrating a further different example of providing a reply interface in a mobile terminal according to one embodiment of the present invention;

FIG. 6 is a diagram illustrating a further different example of providing a reply interface in a mobile terminal according to one embodiment of the present invention;

FIG. 7 is a diagram illustrating an example of providing a recommendation reply area in a reply interface of a mobile terminal according to one embodiment of the present invention;

FIG. 8 is a diagram illustrating a different example of providing a recommendation reply area in a reply interface of a mobile terminal according to one embodiment of the present invention;

FIG. 9 is a diagram illustrating a further different example of providing a recommendation reply area in a reply interface of a mobile terminal according to one embodiment of the present invention;

FIG. 10 is a diagram illustrating an execution screen in accordance with a control input on a recommendation reply area in a reply interface of a mobile terminal according to one embodiment of the present invention;

FIG. 11 is a diagram illustrating an execution screen in accordance with a control input on a recommendation reply area in a reply interface of a mobile terminal according to one embodiment of the present invention;

FIG. 12 is a diagram illustrating a method of configuring detail information of a variable area in a reply interface of a mobile terminal according to one embodiment of the present invention;

FIG. 13 is a diagram illustrating a method of configuring detail information of a variable area in a reply interface of a mobile terminal according to one embodiment of the present invention;

FIG. 14 is a diagram illustrating a method of configuring detail information of a variable area in a reply interface of a mobile terminal according to one embodiment of the present invention;

FIG. 15 is a flowchart for a method of controlling a mobile terminal according to one embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another. When an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Thins such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

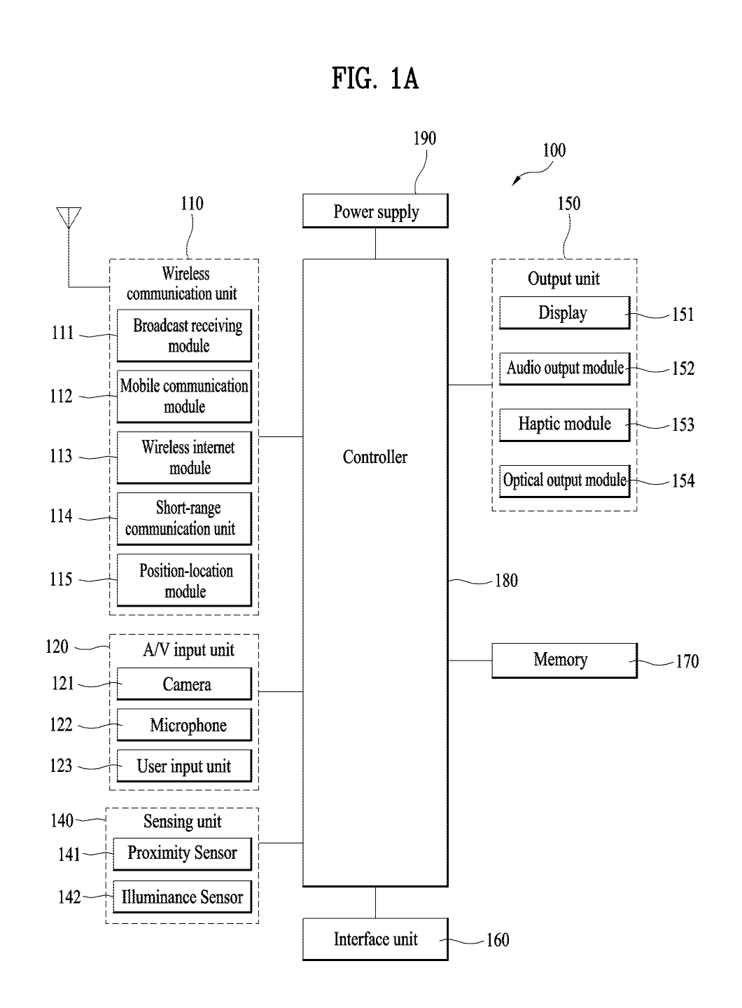

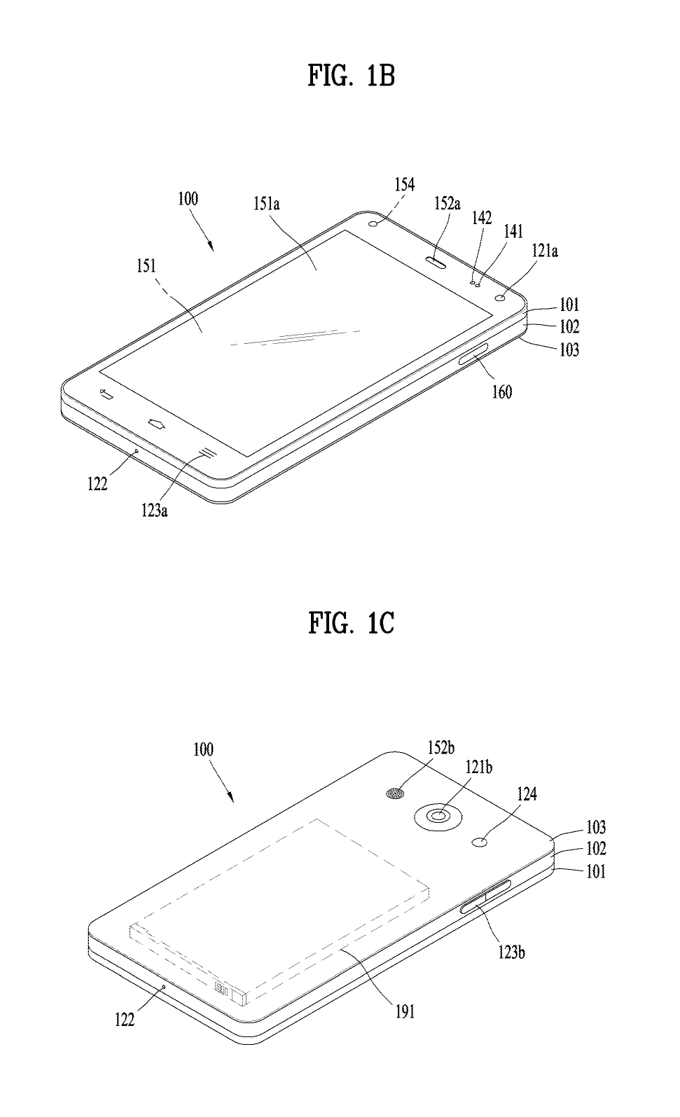

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or a function appropriate for a user by processing a signal, data, information and the like input or output via the aforementioned configuration elements or executing an application program stored in the memory 170.

The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least a part of the configuration elements can operate by cooperating with each other to implement an operation of a mobile terminal, control of the mobile terminal or a method of controlling the mobile terminal according to various embodiments described in the following. And, the operation of the mobile terminal, the control of the mobile terminal or the method of controlling the mobile terminal can be implemented on the mobile terminal by driving at least one or more application programs stored in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this instance, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages. The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 can include the display unit 151, the first and second audio output unit 152a/152b, the proximity sensor 141, the illumination sensor 142, the optical output unit 154, the first and second camera 121a/121b, the first and second operation unit 123a/123b, the microphone 122, the interface unit 160 and the like.

FIGS. 1B and 1C depict certain components as arranged on the mobile terminal. However, alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a. The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject. As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

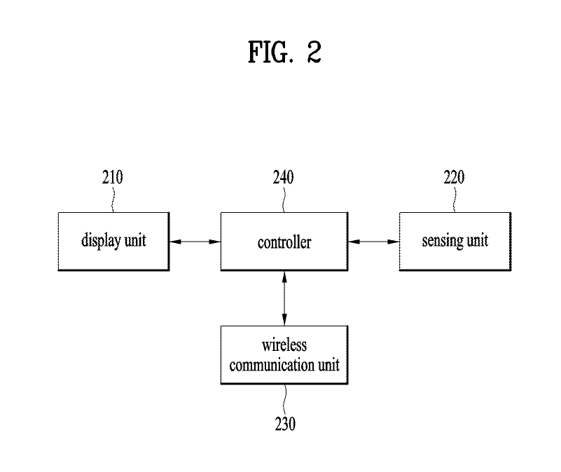

Further preferred embodiments will be described in more detail with reference to additional drawing figures. It is understood by those skilled in the art that the present features can be embodied in several forms without departing from the characteristics thereof. A method of providing a reply interface capable of promptly sending a reply in response to a message in a lock mode of a mobile terminal is explained in the following with reference to FIGS. 2 to 15.

FIG. 2 is a block diagram illustrating a mobile terminal according to one embodiment of the present invention. According to an embodiment of the present invention, a mobile terminal can include a display unit 210, a sensing unit 220, a wireless communication unit 230, and a controller 240. In addition, the mobile terminal can further include a memory. And, a configuration module installed in the mobile terminal is not restricted by the aforementioned modules and may further include various configuration modules.

The display unit 210 can display visual information. In this instance, the visual information can include content, an application, an image, a video, an icon, and the like. And, the display unit 210 can display information processed in the mobile terminal. For example, the display unit 210 basically outputs various images and text information and can display UI (user interface) and GUI (graphic user interface) according to information on an execution screen of an application program executed in the mobile terminal. In addition, the display unit 210 can output the visual information on a screen based on a control command of the controller 240.

In the present invention, the display unit 210 can be implemented by the display unit 151 shown in FIG. 1A. In the present invention, the display unit 210 can be implemented in a touch screen form together with the sensing unit 220. According to one embodiment of the present invention, the display unit 210 can output a received message and a reply interface.

The sensing unit 220 senses various inputs of a user input on a mobile terminal and environment of the mobile terminal and delivers a sensed result to the controller 240 to enable the controller 240 to perform an operation according to the sensed result. In the present invention, the sensing unit 220 can be implemented by the sensing unit 140 or the input unit 120 shown in FIG. 1A. According to one embodiment of the present invention, the sensing unit 220 can sense a direct touch and a proximity touch (e.g., hovering) via touch recognition of a capacitive type.

Also, in case of sensing a proximity touch and a direct touch, the sensing unit 220 can sense not only a point corresponding to a single input but also points corresponding to a plurality of inputs. According to one embodiment of the present invention, a mobile terminal equipped with a touch sensor can sense various direct touches including a short touch, a long touch, a drag touch, and the like. According to one embodiment of the present invention, the sensing unit 220 can sense a current status of the mobile terminal via various sensor such as a microphone, a camera, a gyro sensor, an acceleration sensor and the like mounted on the mobile terminal.

The wireless communication unit 230 can perform communication with an external device using various protocols and transmit/receive data with the external device. And, the wireless communication unit 230 accesses a network in wired or wireless to transmit/receive digital data such as contents and the like with the network. In the present invention, the wireless communication unit 230 can be implemented by the wireless communication unit 140 shown in FIG. 1a. According to one embodiment of the present invention, the wireless communication unit 230 can transceive a message with an external device. And, according to one embodiment of the present invention, the wireless communication unit 230 can transceive message information and information on a reply interface with a server.

The controller 240 processes data, controls the aforementioned units of the mobile terminal, and controls data transmission/reception between units. In the present invention, the controller 240 can be implemented by the controller 180 of FIG. 1a. According to one embodiment of the present invention, if a control input on a received message is sensed, the controller 240 can control a reply interface to be output.

As one embodiment of the present invention, operations performed by the mobile terminal can be controlled by the controller 240. Yet, for clarity, it is explained as the operations are commonly performed by the mobile terminal in the drawings and the description described in the following.

### Reply Interface Configuration and Area Switching

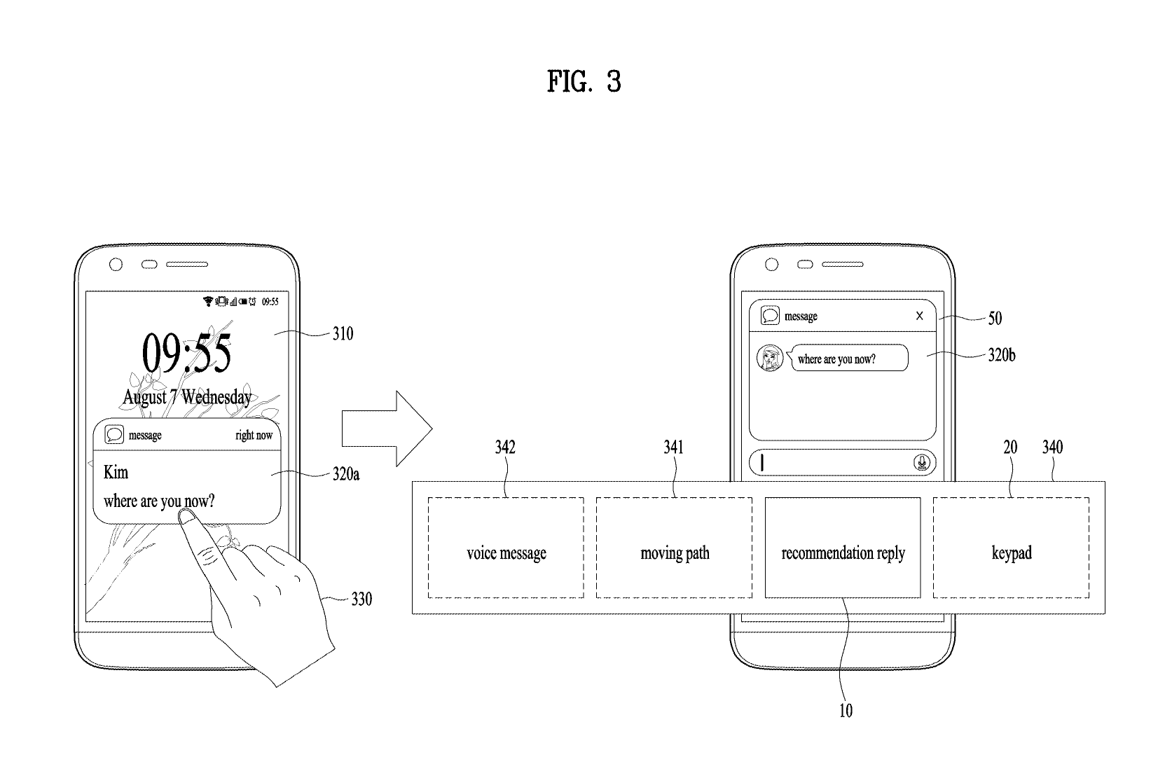

FIG. 3 is a diagram illustrating an example of providing a reply interface in a mobile terminal according to one embodiment of the present invention. First of all, the mobile terminal can receive a message in a lock mode. In this instance, the lock mode may correspond to a state that the display unit of the mobile terminal is inactivated. In addition, the lock mode may correspond to a state that a lock screen is output when the display unit of the mobile terminal is activated. In addition, the received message can include not only a message received via a message application basically installed in the mobile terminal but also a message received via a third party application.

As shown in a first drawing of FIG. 3, the mobile terminal can output the received message 320a on the display unit. More specifically, the mobile terminal can output the received message 320a on a lock screen 310. In this instance, the mobile terminal can sense a control input 330 input on the received message 320a. For example, the control input 330 can include various touch inputs including a short touch, a long touch, a press touch and the like.

Further, the mobile terminal can analyze contents of the received message 320a in response to the control input 330 and can analyze a current status of the mobile terminal. As an example, the mobile terminal transmits the contents of the received message 320a to a server and can extract a recommended reply according to the analysis of the server. As a different example, the mobile terminal can analyze a current status via various sensors included in the sensing unit mounted on the mobile terminal. For example, the mobile terminal can recognize a driving situation through a front camera or a rear camera mounted on the mobile terminal. The mobile terminal can recognize a cooking situation via a microphone mounted on the mobile terminal and recognize a traveling situation via a sensor mounted on the mobile terminal.

By doing so, as shown in a second drawing of FIG. 3, the mobile terminal can output a conversation area 50 including a received message 320b and a reply interface 340 on the lock screen. The received message 320b may correspond to a message identical to the received message shown in the first drawing of FIG. 3 or a message including all conversation contents transmitted/received with a partner. The reply interface 340 may correspond to various options that enable a user of the mobile terminal to send a reply in response to the received message. Although it is depicted as the reply interface 340 is output when a reply is sent in a lock state, the reply interface can also be output when a message application is executed.

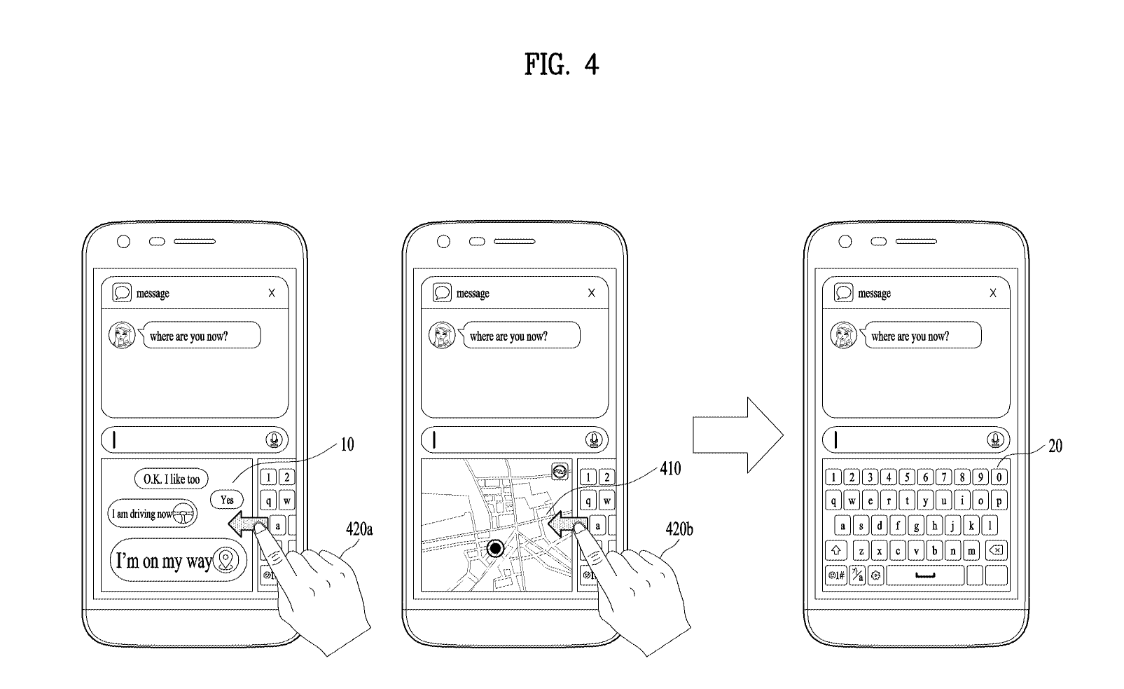

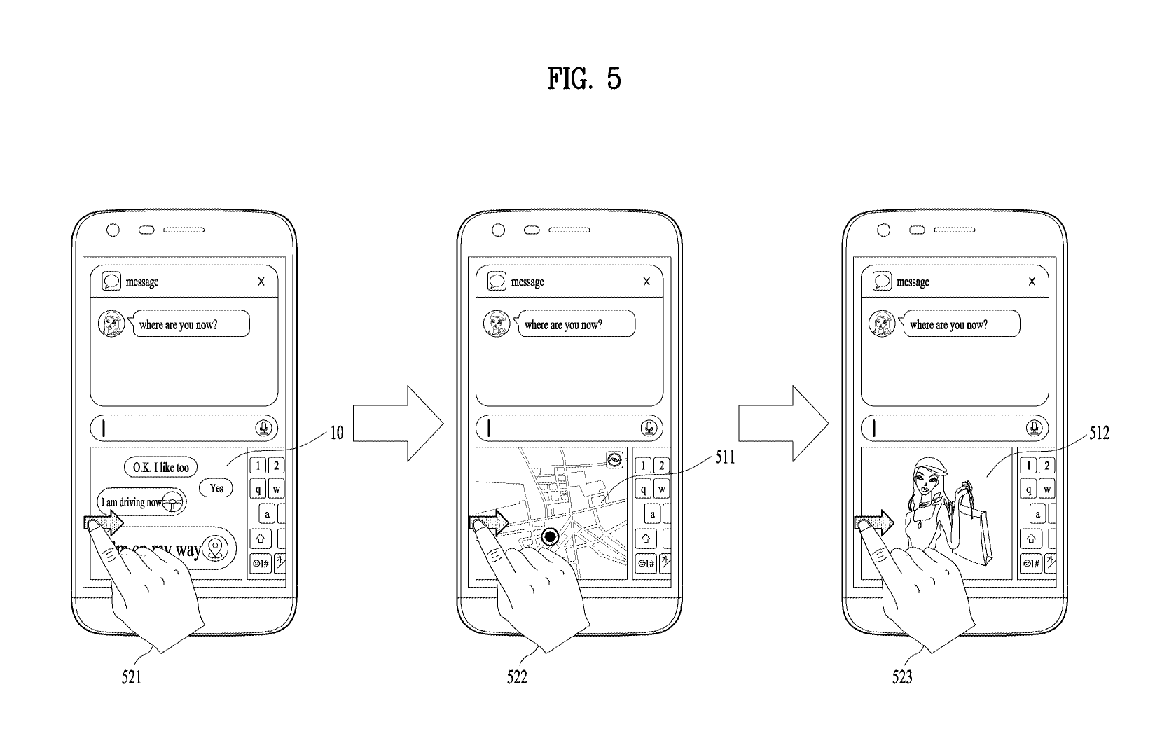

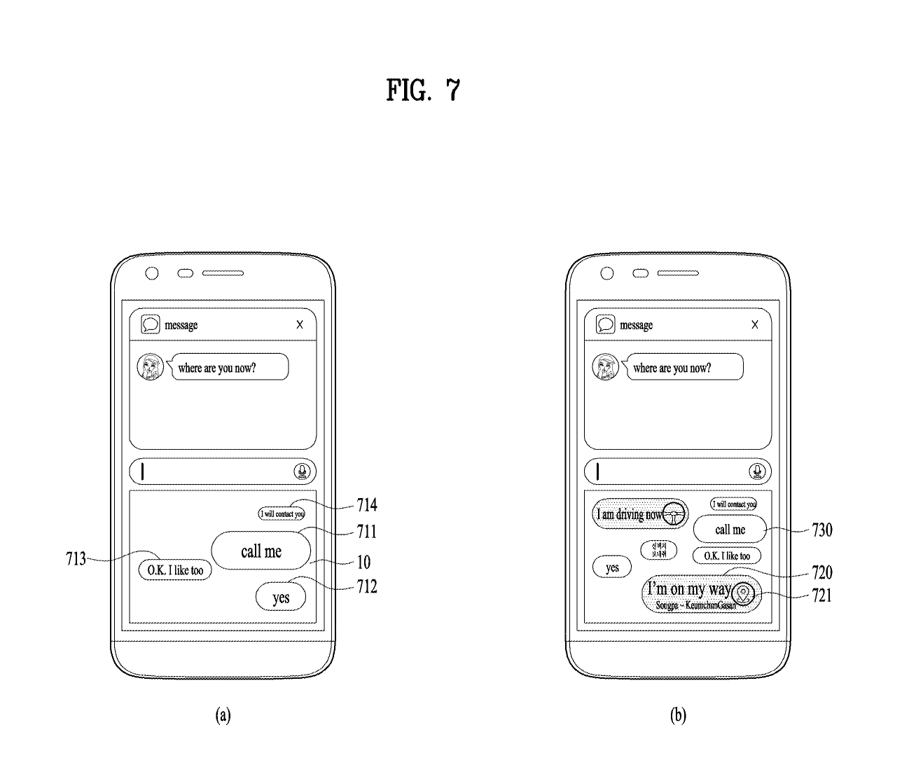

First of all, the reply interface 340 can include a plurality of areas and include a recommendation reply area 10 and a keypad area 20 as areas provided all the time. In particular, when the reply interface 340 is output, the mobile terminal can include the recommendation reply area 10 and the keypad area 20 as default. When the reply interface 340 is output on the display unit, the mobile terminal can output a main area only among a plurality of the areas. For example, when the reply interface 340 is output, the mobile terminal can control the recommendation reply area 10 to be output on the display unit as a default area. The mobile terminal can output other areas rather than the recommendation reply area 10 on the display unit according to a control input of a user. This will be described in FIGS. 4 and 5. Meanwhile, the recommendation reply area 10 can be output in various ways, which will be described in FIGS. 7 to 14.

The reply interface 340 can additionally provide a variable area which is determined according to content of a message and a current status of the mobile terminal. For example, if message content and a status recognized by the mobile terminal correspond to in class, the mobile terminal can include a calendar area and a map area as a variable area. In this instance, the calendar area can display a schedule of a user of the mobile terminal and the map area can display a current location of the user.

If message content and a status recognized by the mobile terminal correspond to a cooking situation, the mobile terminal can include a gallery area and a video call area as a variable area. As shown in FIG. 3, if message content and a status recognized by the mobile terminal correspond to a driving situation, the mobile terminal can include a moving path area 341 and a voice message area 342 as a variable area. The moving path area 341 can display a path between a point of departure and a destination of a user and the voice message area 342 corresponds to an area for inducing a driving user to transmit a voice message to a counterpart. If the sensed control input 330 corresponds to an input for cancelling a lock screen, the mobile terminal executes a message application in an unlock mode and can provide a keypad for a received message and a reply.

Next, FIG. 4 is a diagram illustrating a different example of providing a reply interface in a mobile terminal according to one embodiment of the present invention. More specifically, FIG. 4 shows a method of providing a keypad area all the time according to a direction of a control input when a reply interface is output.

As an example, referring to the first drawing of FIG. 4, the mobile terminal can sense a control input 420a when a recommendation reply area 10 is output in the reply interface. For example, the control input 420a may correspond to a drag touch dragged in left direction or a flicking touch. As shown in the third drawing of FIG. 4, the mobile terminal can output a keypad area 20 in the reply interface.

As a different example, referring to the second drawing of FIG. 4, the mobile terminal can sense a control input 420b when a map area 410 is output in the reply interface. For example, the control input 420b may correspond to a drag touch dragged in left direction or a flicking touch. In this instance, as shown in the third drawing of FIG. 4, the mobile terminal can output a keypad area 20 in the reply interface.

In particular, if a drag touch dragged in one direction or a flicking touch is sensed in the reply interface, the mobile terminal can control the frequently used keypad area 20 to be output all the time. As a result, a user can use the keypad area all the time via a drag touch input in one direction while using a different variable area. For example, one direction may correspond to a left direction or right direction and can be differently configured according to a user setting or a terminal setting.

Next, FIG. 5 is a diagram illustrating a different example of providing a reply interface in a mobile terminal according to one embodiment of the present invention. More specifically, FIG. 5 shows a method of moving a plurality of areas except a keypad area when a reply interface is output.

Referring to the first drawing of FIG. 5, the mobile terminal can sense a first control input 521 when a recommendation reply area 10 is output in the reply interface. For example, the first control input 521 may correspond to a drag touch or a flicking touch in left direction. In this instance, the mobile terminal can output one area among a plurality of the areas included in the reply interface except the recommendation reply area 10 and the keypad area. As mentioned earlier in FIG. 4, since the keypad area is output only when a flicking touch in left direction is sensed and the recommendation reply area 10 is currently output, the mobile terminal can output an area except the above-mentioned two areas among a plurality of the areas.

For example, as shown in the second drawing of FIG. 5, the mobile terminal can output a map area 511 in the reply interface in response to the first control input 521. In this instance, the mobile terminal can sense a second control input 522 when the map area 511 is output. For example, the second control input 522 may correspond to a flicking touch or a drag touch in right direction. The mobile terminal can output an area except the recommendation reply area 10, the keypad area, and the map area 511 among a plurality of the areas included in the reply interface.

As shown in the third drawing of FIG. 5, the mobile terminal can output a gallery area 512 in the reply interface in response to the second control input 522. The mobile terminal can sense a third control input 523 when the gallery area 512 is output. For example, the third control input 523 may correspond to a flicking touch or a drag touch in right direction. Further, the mobile terminal can output an area except the recommendation reply area 10, the keypad area, the map area 511, and the galley area among a plurality of the areas included in the reply interface. Or, if all areas except the keypad area among a plurality of the areas are output, the mobile terminal can output the recommendation reply area 10 again.

Referring to FIG. 5, the reply interface can output a preview of the keypad area at one side of an area output on the display unit. As mentioned earlier in FIG. 4, this is because, if a control input in left direction is sensed, the keypad area is output all the time. In particular, if a drag touch or a flicking touch in a direction opposite to the direction of FIG. 4 is sensed, the mobile terminal can control the remaining areas except the keypad area among a plurality of the areas to be sequentially output.

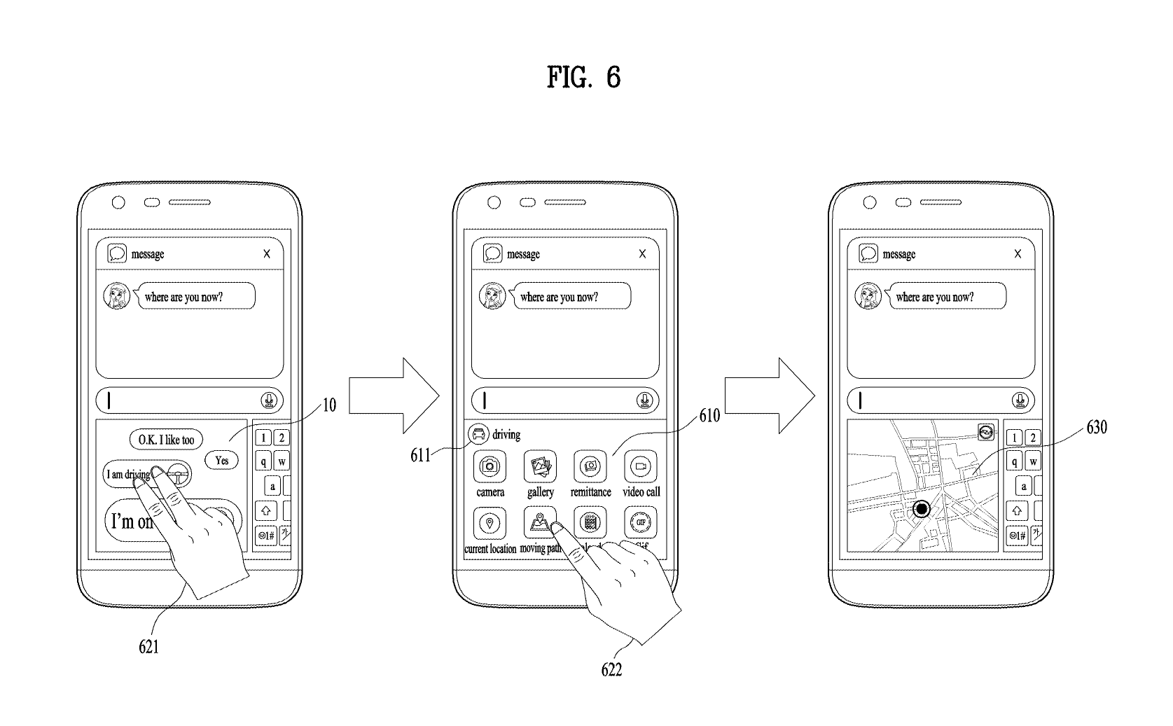

Next, FIG. 6 is a diagram illustrating a further different example of providing a reply interface in a mobile terminal according to one embodiment of the present invention. More specifically, FIG. 6 shows a method of outputting a list of all areas when one area is output in the reply interface.

Referring to the first drawing of FIG. 6, the mobile terminal can sense a first control input 621 when one area is output in the reply interface. For example, the output area may correspond to a recommendation reply area 10, by which the present invention may be non-limited. In this instance, the first control input 621 may correspond to a multi-touch input such as a press touch as a multi-touch input. In particular, the first control input 621 may correspond to a touch input for putting pressure on the display unit using two fingers.

In this instance, the mobile terminal can control a list 610 of all areas to be output in the reply interface in response to the first control input 621. The list 610 of all areas corresponds to a list that indicates all of a plurality of areas, which are extracted based on contents of a received message and a current status of the mobile terminal. The mobile terminal can output a current status indicator 611 at one side of the reply interface. The mobile terminal can indicate a current status of the mobile terminal to a user via the current status indicator.

Referring to the second drawing of FIG. 6, the mobile terminal can sense a second control input 622 input on one area included in the list 610 of all areas. For example, the second control input 622 may correspond to a single tap touch. In an embodiment of FIG. 6, the second control input 622 may correspond to an input for selecting a moving path area. In this instance, as shown in the third drawing of FIG. 6, the mobile terminal can output the selected moving path area 630 in the reply interface.

### Method of Outputting Recommendation Reply Area of Reply Interface

As mentioned in the foregoing description, a recommendation reply area among a plurality of areas included in the reply interface all the time as a default area can be provided. Further, at least one or more replies included in the recommendation reply area correspond to replies extracted based on the context of a message transmitted and received between the mobile terminal and a counterpart device. In the present invention, assume that the at least one or more extracted replies are provided in a form of a speech bubble (speech balloon).

A method of arranging and outputting at least one or more speech bubbles in a recommendation reply area, which is recommended based on the context of a message, is explained in the following with reference to FIGS. 7 to 9. In particular, FIG. 7 is a diagram illustrating an example of providing a recommendation reply area in a reply interface of a mobile terminal according to one embodiment of the present invention.

A recommendation reply area 10 can include at least one speech bubble. As mentioned in the foregoing description, the at least one speech bubble included in the recommendation reply area 10 can be determined based on the context of a message transmitted/received between the mobile terminal and a counterpart device. In addition, the at least one speech bubble included in the recommendation reply area 10 can be received by being extracted by the controller of the mobile terminal or an external server connected with the mobile terminal.

As an example, a size of the at least one speech bubble included in the recommendation reply area 10 can be determined based on a relation with the transmitted/received message. In particular, if it is highly probable that a message is to be selected by a user of the mobile terminal based on the context of the message transmitted/received between the mobile terminal and a counterpart device, the mobile terminal can increase the size of the speech bubble.

Referring to FIG. 7 (a), there are 4 speech bubbles included in the recommendation reply area 10. The speech bubbles correspond to ‘Call me’ reply 711, ‘Yes’ reply 712, ‘Yes, I like too’ reply 713, and ‘O.K. I will contact you’ reply 714. Among a plurality of speech bubbles, a size of the ‘Call me’ reply 711 is largest. In particular, the ‘Call me’ reply 711 corresponds to a message that a choice probability of a user is highest. Among a plurality of speech bubbles, a size of the ‘O.K. I will contact you’ reply 714 is smallest. In particular, the ‘O.K. I will contact you’ reply 714 corresponds to a message that a choice probability of a user is lowest.

As a different example, a color of at least one speech bubble included in the recommendation reply area 10 can be differently output depending on whether a reply corresponds to a reply including a text message or a reply including additional information as well as a text message. Referring to FIG. 7 (b), the recommendation reply area 10 can be output in two colors. In this instance, in case of a speech bubble including a text message, as mentioned earlier in FIG. 7 (a), a size of the speech bubble can be arranged according to an order of high choice probability. In case of a speech bubble including additional information as well as a text message, the mobile terminal can output the text message and an icon indicating the additional information together. For example, the additional information can include various data such as a moving path, an image, voice, and the like. For example, referring to FIG. 7 (b), in case of ‘I'm on my way’ reply 720, a moving path icon 721 for indicating a path as well as a text message such as ‘I'm on my way’ can be output.

Further, if two or more speech bubbles are recommended to be used together among a plurality of speech bubbles, the mobile terminal can identically output edges of the speech bubbles. For example, in case of speech bubbles ‘O.K.’ and ‘I will be right there’ capable of being recognized as a continuous meaning, the mobile terminal can output edges of the speech bubbles with the same thickness or the same color. In addition, the mobile terminal determines a mood of conversation based on the context of a transmitted/received message and can differently output a font according to the mood. For example, if the mood is determined as solemn and formal based on the context of the message, the mobile terminal can use ‘Times New Roman’ font. If the mood is determined as soft, the mobile terminal can use ‘Arial’ font, by which the present invention may be non-limited.

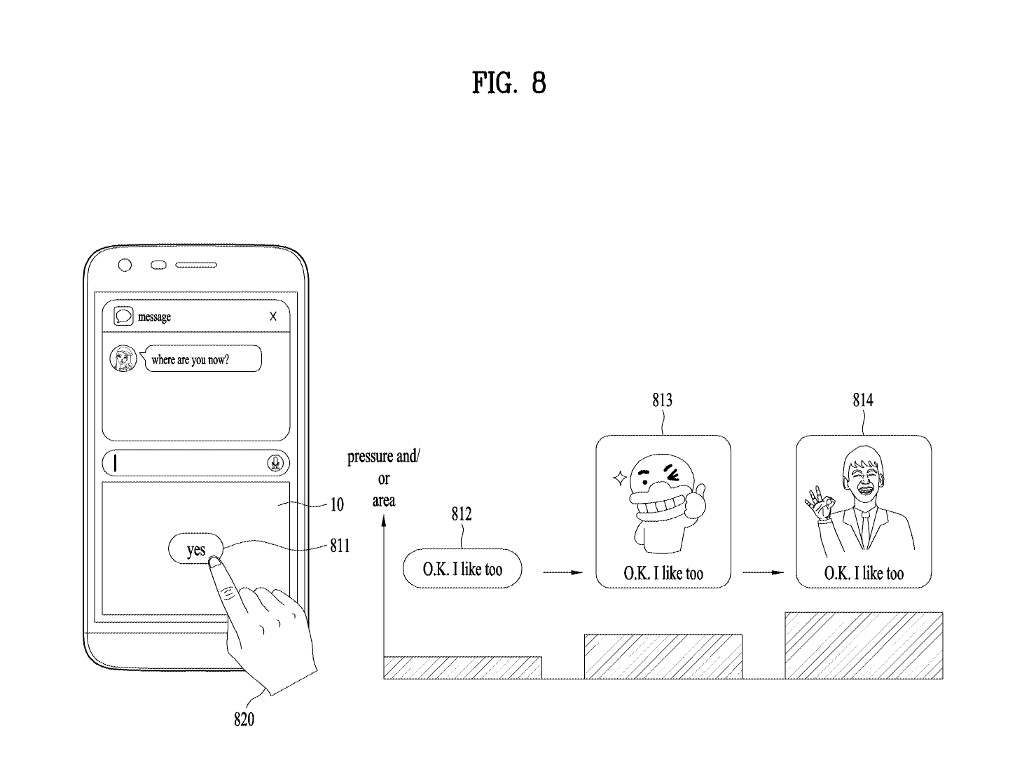

Next, FIG. 8 is a diagram illustrating a different example of providing a recommendation reply area in a reply interface of a mobile terminal according to one embodiment of the present invention. More specifically, according to an embodiment of FIG. 8, to the mobile terminal can output a transformed speech bubble according to strength of a control input sensed on the speech bubble output in a recommendation reply area.

First of all, as shown in FIG. 8, the mobile terminal can output a first speech bubble 811 in a recommendation reply area 10. In this instance, the mobile terminal can sense a control input 820 input on the first speech bubble 811. If the control input 820 corresponds to a short touch input, the mobile terminal can output a reply including the first speech bubble 811 in a message input window or can transmit the reply to a counterpart device. Yet, if the control input corresponds to a press touch rather than the short touch input, the mobile terminal can output the first speech bubble 811 by transforming the first speech bubble.

For example, if the control input 820 corresponds to a first press touch, the mobile terminal can output a second speech bubble 812 in the recommendation reply area 10 instead of the first speech bubble 811 that emphasizes the first speech bubble. For example, if the control input 820 corresponds to a second press touch, the mobile terminal can output a third speech bubble 813 in the recommendation reply area 10 instead of the first speech bubble 811 that emphasizes the first speech bubble and add an emoticon. If the control input 820 corresponds to a third press touch, the mobile terminal can output a fourth speech bubble 814 in the recommendation reply area 10 instead of the first speech bubble 811 that emphasizes the first speech bubble and add an animation. In this instance, the second press touch corresponds to a touch input that at least one of pressure and area sensed on a touch screen is greater than the first press touch. The third press touch corresponds to a touch input that at least one of pressure and area sensed on the touch screen is greater than the second press touch.

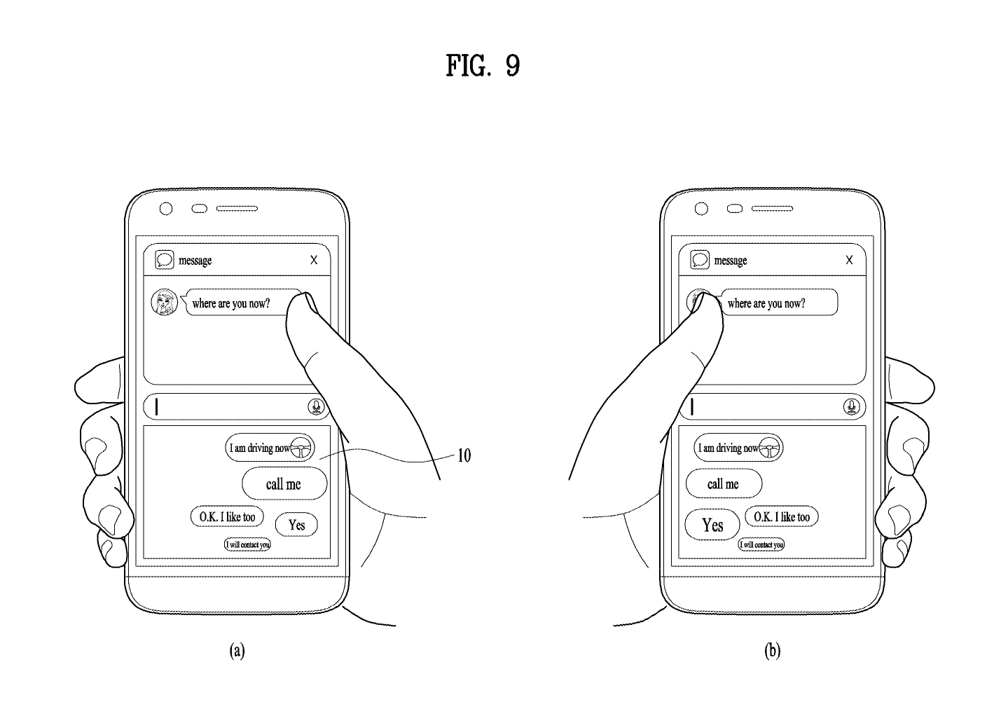

Next, FIG. 9 is a diagram illustrating a further different example of providing a recommendation reply area in a reply interface of a mobile terminal according to one embodiment of the present invention. The mobile terminal can sense a grip state in various ways. As an example, the mobile terminal can sense a hand gripping the mobile terminal by installing a touch sensor in the side of the mobile terminal. For example, when the display unit of the mobile terminal faces the front, if more fingers are sensed at the left side of the mobile terminal, it may correspond to a right hand grip state. If more fingers are sensed at the right side of the mobile terminal, it may correspond to a left hand grip state. In this instance, the mobile terminal can differently output a position of a speech bubble according to a grip state. As a different example, the mobile terminal can determine a grip state based on a direction of a fingerprint sensed by a fingerprint sensor. For example, if a fingerprint is sensed in a state of being inclined to the left, it may correspond to a right hand grip state. If a fingerprint is sensed in a state of being inclined to the right, it may correspond to a left hand grip state.

Referring to FIG. 9 (a), the mobile terminal can output a plurality of speech bubbles included in the recommendation reply area 10 by arranging a plurality of the speech bubbles to the right in the right hand grip state. In addition, referring to FIG. 9 (b), the mobile terminal can output a plurality of speech bubbles included in the recommendation reply area 10 by arranging a plurality of the speech bubbles to the left in the left hand grip state. This is because, since a control input is input by a thumb in general in one hand grip state, it is preferable to arrange a speech bubble to a position capable of being easily reached by a thumb.

Method of Outputting Additional Information of Recommendation Reply Area

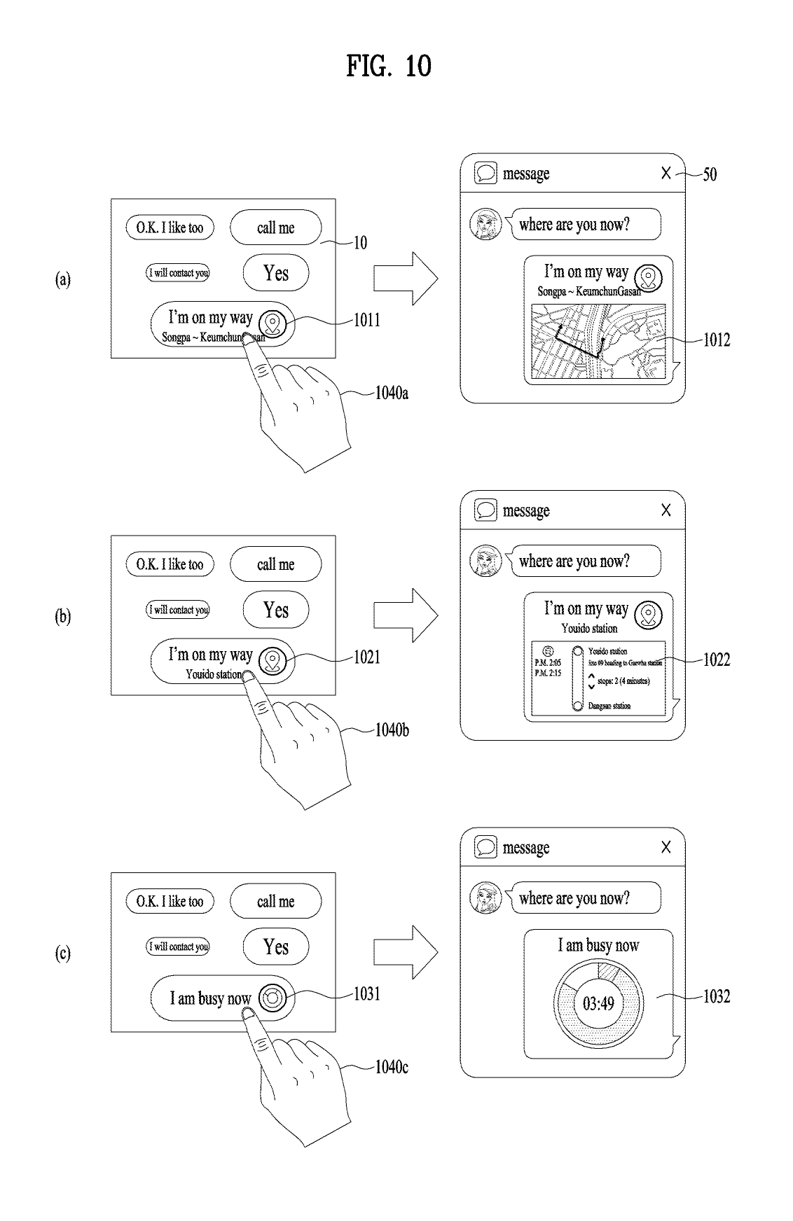

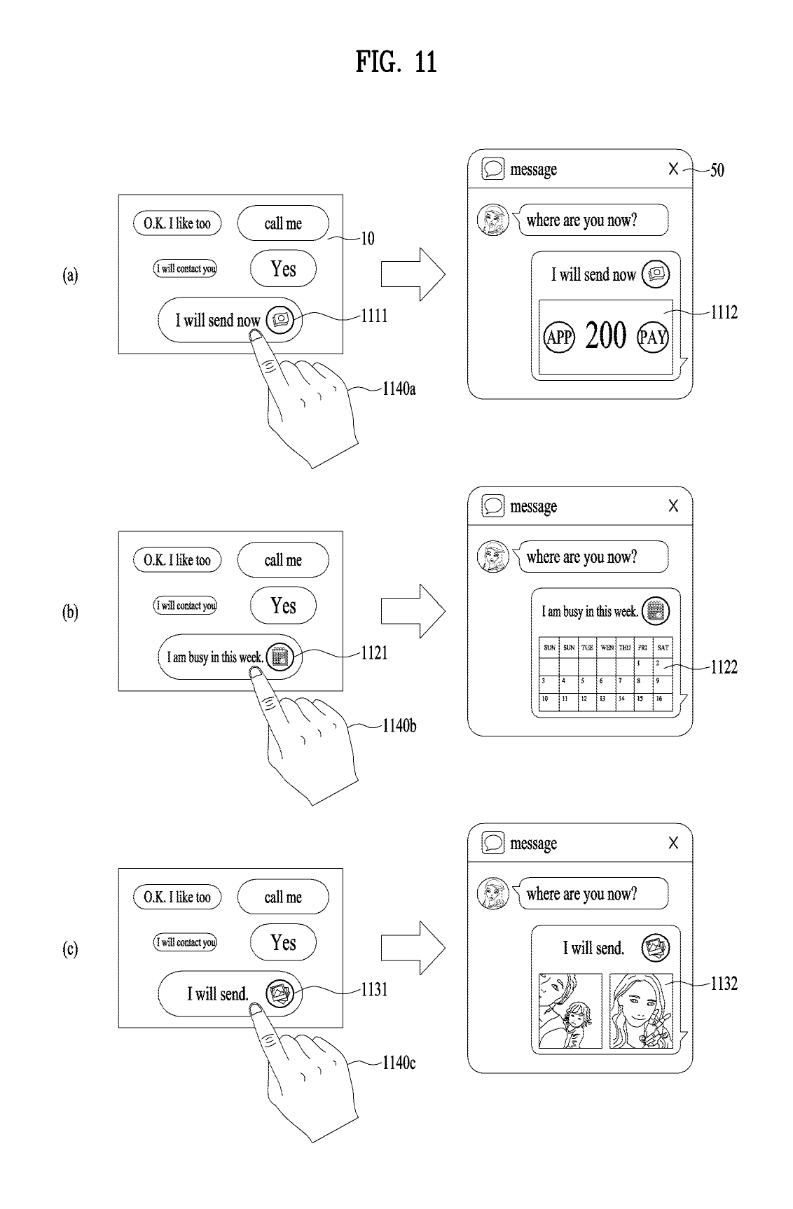

Next, FIGS. 10 and 11 are diagrams illustrating an execution screen in accordance with a control input on a recommendation reply area in a reply interface of a mobile terminal according to one embodiment of the present invention. More specifically, an embodiment of FIG. 10 shows a speech bubble reply for sharing a state of the mobile terminal, and an embodiment of FIG. 11 shows a speech bubble replay for sharing information or contents with a counterpart device.

As mentioned earlier in FIG. 7, the mobile terminal can output additional information as well as a text message to a speech bubble. In this instance, if a speech bubble including a text message only is selected, the mobile terminal outputs the text message included in the speech bubble only in a conversation area 50. On the contrary, if a speech bubble in which a text message and additional information are included is selected, the mobile terminal can output a message in the conversation area 50. The output message is a message corresponding to a speech bubble in which additional information is included. In particular, the output message corresponds to a message that the text message and the additional information included in the speech bubble are output in detail. For example, the additional information included in the speech bubble is output as a simple icon, whereas the additional information in the conversation area 50 may correspond to an execution screen of an application when the application is practically executed.

As an example, referring to FIG. 10 (a), the mobile terminal can sense a control input 1040a on a speech bubble 1011 including a moving path among speech bubbles output in the recommendation reply area 10. For example, the control input 1040a may correspond to a short touch input. In this instance, the mobile terminal can transmit a message included in the speech bubble including the moving path to a counterpart device. In addition, the mobile terminal can output the transmitted message 1012 in a conversation area 50. The output message 1012 can include not only a text message but also detail information on a moving path of the mobile terminal. Further, if a control input on the output message 1012 is sensed in the counterpart device or the mobile terminal, the counterpart device or the mobile terminal executes a map application to output the moving path of the mobile terminal.

As a different example, referring to FIG. 10 (b), the mobile terminal can sense a control input 1040b on a speech bubble 1021 including a subway route among speech bubbles output in the recommendation reply area 10. In this instance, the mobile terminal can transmit a message included in the speech bubble including the subway route to a counterpart device and output the transmitted message 1022 in a conversation area 50. The output message 1022 can include not only a text message but also detail information on a subway route of the mobile terminal. Further, if a control input on the output message 1022 is sensed in the counterpart device or the mobile terminal, the counterpart device or the mobile terminal executes a subway application to output a subway moving path.

As a further different example, referring to FIG. 10 (c), the mobile terminal can sense a control input 1040c on a speech bubble 1031 including a timer among speech bubbles output in the recommendation reply area 10. In this instance, the mobile terminal can transmit a message included in the speech bubble 1031 including the timer to a counterpart device and output the transmitted message 1032 in a conversation area 50. The output message 1022 can include not only a text message but also detail information on the timer of the mobile terminal. In particular, according to the embodiment of FIG. 10 (c), the mobile terminal can transmit timer information corresponding to Do Not Disturb mode.

As a further different example, referring to FIG. 11 (a), the mobile terminal can sense a control input 1140a input on a speech bubble 1111 including remittance information among speech bubbles output in the recommendation reply area 10. In this instance, the mobile terminal can transmit a message included in the speech bubble including the remittance information to a counterpart device and output the transmitted message 1112 in a conversation area 50. Further, if a control input on the output message 1112 is sensed, the mobile terminal executes a bank application to make a remittance to a counterpart account. Or, if a control input on the output message 1112 is sensed, it may make a remittance to a counterpart account though such a procedure as fingerprint authentication without separately executing a bank application.

As a further different example, referring to FIG. 11 (b), the mobile terminal can sense a control input 1140b on a speech bubble 1121 including a schedule icon among speech bubbles output in the recommendation reply area 10. In this instance, the mobile terminal can transmit a message included in the speech bubble 1121 including the schedule icon to a counterpart device and output the transmitted message 1122 in a conversation area 50. The output message 1122 may correspond to a message including detail contents of the schedule icon and an actual calendar. Further, if a control input on the output message 1122 is sensed, the mobile terminal executes a schedule application to provide a schedule to a user of the mobile terminal. If a control input on the output message 1122 is sensed is sensed in the counterpart device, the mobile terminal can magnify and output a schedule included in the output message 1122 without executing the schedule application.

As a further different example, referring to FIG. 11 (c), the mobile terminal can sense a control input 1140c on a speech bubble 1121 including an image icon among speech bubbles output in the recommendation reply area 10. In this instance, the mobile terminal can transmit a message corresponding to the speech bubble 1131 including the image icon to a counterpart device and output the transmitted message 1132 in a conversation area 50. The output message 1132 may correspond to a message including a thumbnail of an actual image corresponding to the image icon. Further, if a control input on the output message 1132 is sensed, the mobile terminal or the counterpart device may magnify and output an image included in the output message 1132.

### Method of Configuring Detail Information of Variable Area

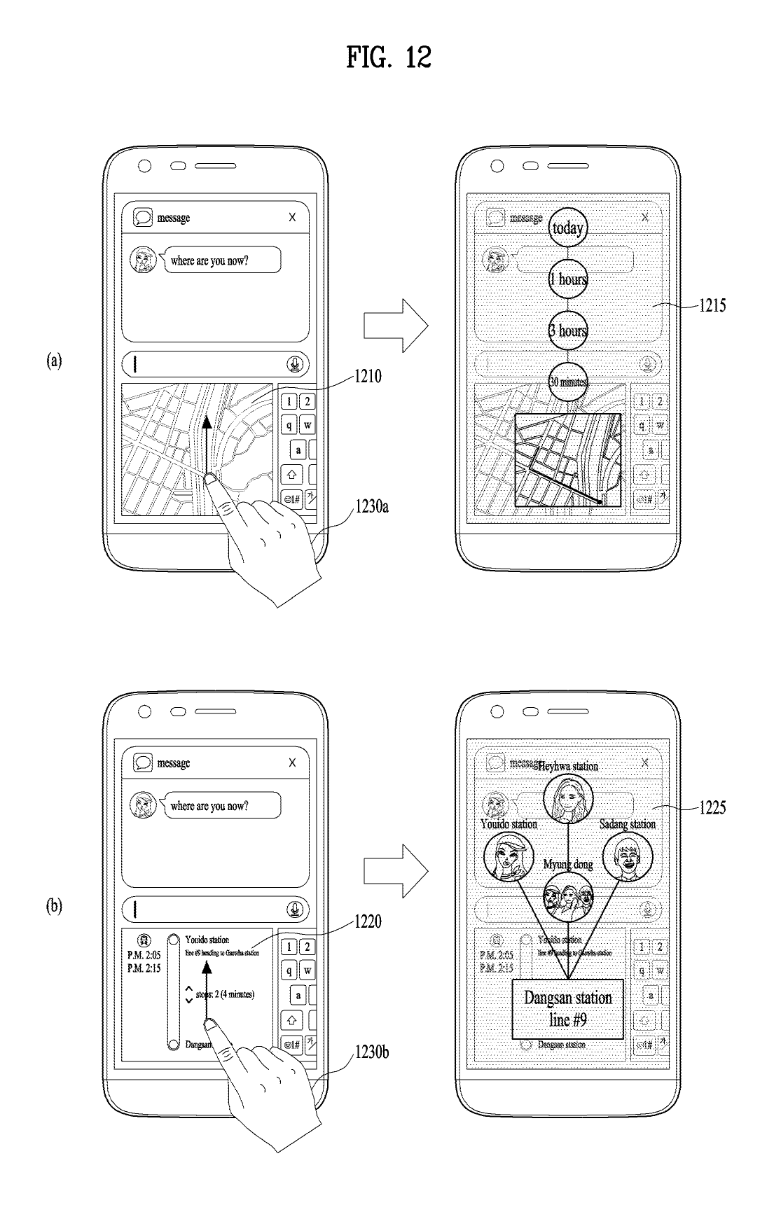

In the following, a method of outputting detail information in a variable area, which varies according to a current status of a mobile terminal, rather than a recommendation reply area of a reply interface is explained. In particular, FIGS. 12 to 14 are diagrams illustrating a method of configuring detail information of a variable area in a reply interface of a mobile terminal according to one embodiment of the present invention.

As mentioned earlier in FIG. 3, a reply interface can include not only a recommendation reply area and a keypad area but also a variable area which is determined according to a current status. For example, the variable area can include a moving path area, a voice message area, a gallery area, a remittance area, and the like. Embodiments of FIGS. 12 to 14 show a method of configuring detail information prior to message transmission when each of the variable areas is selected. In the embodiments of FIGS. 12 to 14, unlike the aforementioned embodiments of FIGS. 10 and 11, assume that a control input corresponds to a drag touch input.

If a drag touch input exceeds a prescribed length range, the mobile terminal can output a detail information pop-up. For example, if a moving distance of a drag touch input exceeds a prescribed length range, the mobile terminal can output detail information pop-up. In this instance, the detail information pop-up 1215 corresponds to a pop-up for configuring information displayed on a variable area in detail. For example, the detail information pop-up output in a moving path area can include a moving time option. The mobile terminal can transmit a message including detail information corresponding to a position at which a touch and drop is performed or a position at which a drag touch is finished on the detail information pop-up to a counterpart device.

As an example, referring to FIG. 12 (a), the mobile terminal can output a moving path area 1210 as a variable area of a reply interface. The mobile terminal can sense a control input 1230a input on the moving path area 1210. In this instance, the control input 1230a corresponds to a drag touch input in one direction. If the drag touch input exceeds a prescribed length range, as shown in the second drawing of FIG. 12 (a), the mobile terminal can output detail information pop-up 1215 including at least one or more moving time menus. Further, the control input 1230a can be continuously input on the detail information pop-up 1215. The mobile terminal can transmit a moving time menu corresponding to a point at which the drag touch is finished to a counterpart device.

As a different example, referring to FIG. 12 (b), the mobile terminal can output a subway route area 1220 as a variable area of a reply interface. The mobile terminal can sense a control input 1230b on the subway route area 1220. If the drag touch input exceeds a prescribed length range, as shown in the second drawing of FIG. 12 (b), the mobile terminal can output detail information pop-up 1225 including at least one or more subway menus. In this instance, the at least one or more subway menus can include distance and time for a station at which a counterpart participating in the conversation is located. If a plurality of counterparts are participating in the conversation, the at least one or more subway menus may correspond to a subway station located in the middle based on locations of all counterparts. Further, the mobile terminal can transmit a menu corresponding to a point at which the drag touch is finished to a counterpart device.

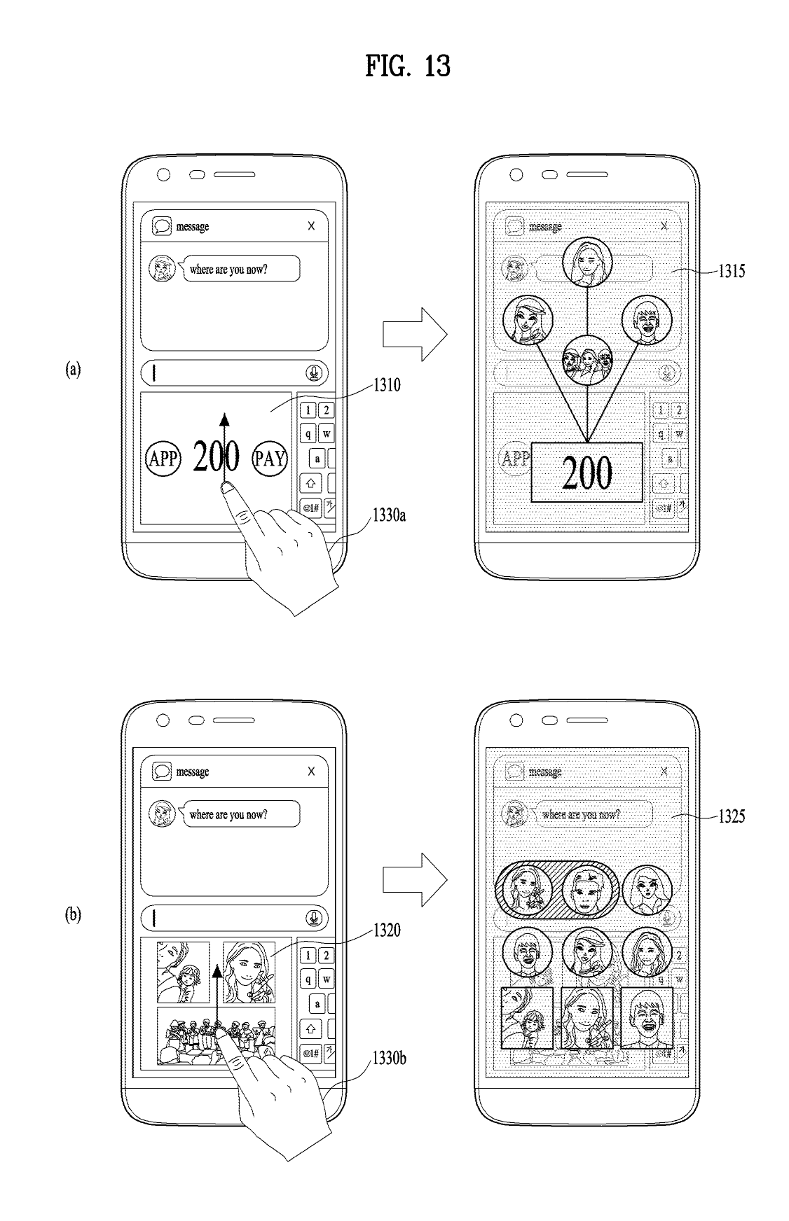

As a further different example, referring to FIG. 13 (a), the mobile terminal can output a remittance area 1310 as a variable area of a reply interface. The mobile terminal can sense a control input 1330a input on the remittance area 1310. If the drag touch input exceeds a prescribed length range, as shown in the second drawing of FIG. 13 (a), the mobile terminal can output detail information pop-up 1315 including a remittance target. In this instance, the detail information pop-up 1315 can include an icon indicating each of counterparts participating in conversation or an icon indicating all counterparts participating in the conversation. The control input 1330a can be continuously input after the detail information pop-up 1315 is output in the remittance area 1310. The mobile terminal can also execute a remittance application to make a remittance to a counterpart corresponding to a point at which the drag touch is finished.

As a further different example, referring to FIG. 13 (b), the mobile terminal can output a gallery area 1320 as a variable area of a reply interface. The mobile terminal can sense a control input 1330b on the gallery area 1320. If the drag touch input exceeds a prescribed length range, as shown in the second drawing of FIG. 13 (b), the mobile terminal can output detail information pop-up 1325 including an image transmission target. In this instance, the detail information pop-up 1325 may correspond to an icon indicating a person included in an image. The control input 1330b can be continuously input after the detail information pop-up 1325 is output in the gallery area 1320. Further, the mobile terminal can transmit the image output in the gallery area 1320 to a device of a counterpart corresponding to a point at which the drag touch is finished.

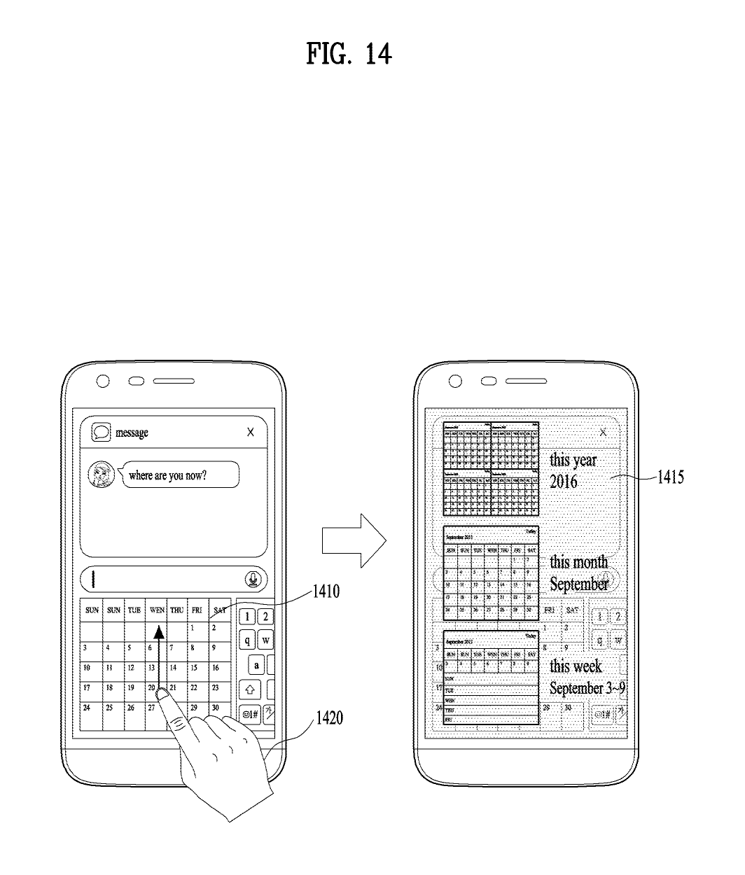

As a further different example, referring to FIG. 14, the mobile terminal can output a schedule area 1410 as a variable area of a reply interface. The mobile terminal can sense a control input 1420 on the schedule area 1410. If the drag touch input exceeds a prescribed length range, as shown in the second drawing of FIG. 14, the mobile terminal can output detail information pop-up 1415 including duration of a schedule to be shared. In this instance, the detail information pop-up 1415 may correspond to duration, which is to be shared with a conversation partner, of a schedule of an owner of the mobile terminal. The control input 1520 can be continuously input after the detail information pop-up 1415 is output in the schedule area 1410. Further, the mobile terminal can transmit a schedule corresponding to a point at which the drag touch is finished to a device of a counterpart as a message.

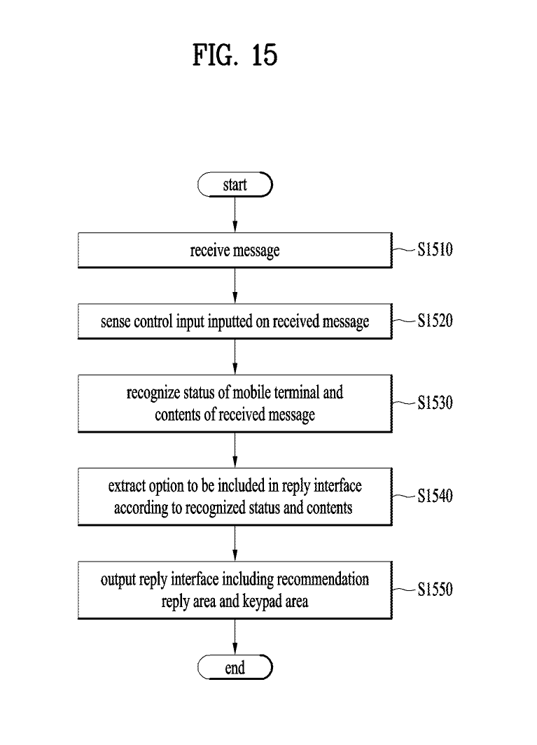

Next, FIG. 15 is a flowchart for a method of controlling a mobile terminal according to one embodiment of the present invention. The mobile terminal can receive a message (S1510). In this instance, the received message may correspond to a message received not only by a message application included in the mobile terminal by default but also by a third party application. As mentioned earlier in FIG. 3, the mobile terminal can receive a message in a lock mode.

Subsequently, the mobile terminal can sense a control input on the received message (S1520). In this instance, the control input may correspond to an input for outputting a reply interface to send a reply in response to the received message. In addition, the mobile terminal can recognize a current status of the mobile terminal and contents of the received message in response to the control input (S1530). The mobile terminal can extract an option to be included in the reply interface according to the recognized status and the contents of the message (S1540). In this instance, the reply interface corresponds to an interface capable of transmitting a reply in the lock mode without executing a message application by switching the mobile terminal into an unlock state.

In addition, the mobile terminal can output a reply interface including a recommendation reply area and a keypad area on the display unit (S1550). For example, as mentioned earlier in FIG. 3, if the reply interface is output, the recommendation reply area can be output by default.

According to at least one embodiment of the present invention, to the mobile terminal can quickly provide a reply interface to a user in a lock mode. For example, a user with a reply interface including an option capable of being selected by the user in consideration of contents of a message transmitted/received with a counterpart device and a current status of a mobile terminal can be provided.

Although each drawing is explained by being divided, embodiments described for each drawing can be combined with each other to implement a new embodiment. In addition, as mentioned in the foregoing description, a voice text conversion display device and a method of controlling therefor are not restricted by the configuration and the method of the embodiments. In order to make various modifications from the embodiments, all or a part of each embodiment can be configured by being selectively combined.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. The foregoing embodiments are merely exemplary and are not to be considered as limiting the present disclosure.

The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments. As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A mobile terminal, comprising:
a wireless communication processor configured to wirelessly receive a message from another terminal;
a touchscreen configured to display contents of the received message; and
a controller configured to:
in response to a first control input on the displayed message, display a reply interface including a recommendation reply area having plurality of preset response options for responding to the received message, based on a current status of the mobile terminal and a meaning of the contents of the received message.

2. The mobile terminal of claim 1, wherein the controller is further configured to:
enter a lock state and display a lock screen on the touchscreen, and
display the contents of the received message on the lock screen without releasing the lock state of the mobile terminal.

3. The mobile terminal of claim 1, wherein the controller is further configured to:
slidably display a keypad area on the touchscreen in response to a second control input in a first direction on the reply interface.

4. The mobile terminal of claim 3, wherein the controller is further configured to display the keypad area in place of the reply interface in response to the second control input.

5. The mobile terminal of claim 4, wherein the controller is further configured to:
in response to a third control input in a second direction on the reply interface, display a partial portion of the keypad area while slidably displaying a plurality of other areas contained in the reply interface including at least one of map screen, a subway route screen, a payment screen, a gallery screen and a schedule screen.

6. The mobile terminal of claim 5, wherein the controller is further configured to:
in response to a fourth control input on the reply interface, display a plurality of application icons on the touchscreen for executing applications on the mobile terminal instead of the reply interface.

7. The mobile terminal of claim 6, wherein the controller is further configured to display a status indicator indicating the current status of the mobile terminal with the plurality of application icons.

8. The mobile terminal of claim 5, wherein the controller is further configured to:
in response to a fourth control input on one of the plurality of other areas, display a detail information pop-up of the one other area by being overlaid on the touchscreen.

9. The mobile terminal of claim 8, wherein if a moving distance of the fourth control input exceeds a predetermined length range, the controller is further configured to display the detail information pop-up by being overlaid and set a menu corresponding to a point at which the fourth control input is finished among at least one or more menus contained in the detail information pop-up.

10. The mobile terminal of claim 1, wherein the controller is further configured to display the recommendation reply area by default when displaying the reply interface.

11. The mobile terminal of claim 1, wherein the recommendation reply area includes a plurality of speech bubbles based on the contents of the received message, and
wherein the controller is further configured to differently output at least one of a size and a color of the speech bubbles based on a relation with the contents of the received message.

12. The mobile terminal of claim 11, wherein the color of the speech bubbles is differently output according to whether or not additional information is included in the received message.

13. The mobile terminal of claim 12, wherein the controller is further configured to display a detail screen corresponding to the additional information in a conversation area of the touchscreen in response to a second control input on a corresponding speech bubble.

14. The mobile terminal of claim 11, wherein a first speech bubble among the plurality of bubbles includes a reply to the message, and
wherein the controller is further configured to:
in response to a second control input on the first speech bubble, transmit the reply to the at least one other terminal if the second control input does not exceed a predetermined strength, and transform the first speech bubble into another more detailed reply if the second control input exceeds the predetermined strength.

15. The mobile terminal of claim 14, wherein the controller is further configured to transform the text message with an emphasizing expression according to an exceeding level of the second control input.

16. The mobile terminal of claim 11, wherein the controller is further configured to change positions of the plurality of bubbles according to a grip state of a user of the mobile terminal.

17. A method of controlling a mobile terminal, the method comprising:
wirelessly receiving, via a wireless communication processor, a message from another terminal;
displaying, via a touchscreen of the mobile terminal, contents of the received message; and
in response to a first control input on the displayed message, displaying, via a controller of the mobile terminal, a reply interface including a recommendation reply area having plurality of preset response options for responding to the received message, based on a current status of the mobile terminal and a meaning of the contents of the received message.

18. The method of claim 17, further comprising:
entering, via the controller, a lock state and display a lock screen on the touchscreen; and
displaying the contents of the received message on the lock screen without releasing the lock state of the mobile terminal.

19. The method of claim 17, further comprising:
slidably displaying a keypad area on the touchscreen in response to a second control input in a first direction input on the reply interface.

20. The method of claim 19, further comprising displaying the keypad area in place of the reply interface in response to the second control input.
